(19) United States
(12) Patent Application Publication
(10) Pub. No.: US 2015/0015993 A1
(43) Pub. Date: Jan. 15, 2015

(54) BASE ASSEMBLY, SPINDLE MOTOR AND HARD DISK DRIVE INCLUDING THE SAME

(71) Applicant: SAMSUNG ELECTRO-MECHANICS CO., LTD., Suwon-si (KR)

(72) Inventors: Hyun Chul Lee, Suwon-si (KR); Shin Young Cheong, Suwon-si (KR)

(73) Assignee: SAMSUNG ELECTRO-MECHANICS CO., LTD., Suwon-si (KR)

(21) Appl. No.: 14/162,676

(22) Filed: Jan. 23, 2014

(30) Foreign Application Priority Data
Jul. 15, 2013 (KR) 10-2013-0082821

(51) Int. Cl. H02K 5/22; G11B 19/20

(52) U.S. Cl. CPC H02K 5/225; G11B 19/2009
USPC 360/99.08; 310/71

(57) ABSTRACT

There is provided a base assembly including: a base member formed by performing plastic deformation on a steel sheet to be at least partially bent; and a flexible printed circuit board disposed on a bottom surface of the base member, wherein a surface having the flexible printed circuit board disposed thereon on the bottom surface of the base member is flat.

### CROSS-REFERENCE TO RELATED APPLICATION

This application claims the benefit of Korean Patent Application No. 10-2013-0082821 filed on Jul. 15, 2013, with the Korean Intellectual Property Office, the disclosure of which is incorporated herein by reference.

### BACKGROUND

The present disclosure relates to a base assembly, a spindle motor and a hard disk drive including the same.

Generally, a small spindle motor used in a hard disk drive (HDD) serves to rotate a disk so that a magnetic head may write data to the disk or read data written on the disk.

In such a hard disk drive, such a small spindle motor is used.

The small spindle motor uses a hydrodynamic bearing assembly. A lubricating fluid is interposed between a shaft and a sleeve of the hydrodynamic bearing assembly, such that the shaft is supported by dynamic fluid pressure generated in the lubricating fluid.

A flexible printed circuit board is fixed to a base member of the spindle motor and power is applied to a coil through the flexible printed circuit board.

In the case in which the base member is not formed to be flat, but has a curved shape having a predetermined radius of curvature, there is a risk that the flexible printed circuit board will be separated from the base member.

### SUMMARY

An aspect of the present disclosure may provide a base assembly capable of preventing a flexible printed circuit board from being separated from a base member by allowing the flexible printed circuit board to be stably fixed to the base member, a spindle motor and a hard disk drive including the same.

According to an aspect of the present disclosure, abase assembly may include: abase member formed by performing plastic deformation on a steel sheet to be at least partially bent; and a flexible printed circuit board disposed on a bottom surface of the base member, wherein a surface having the flexible printed circuit board disposed thereon on the bottom surface of the base member is flat.

The base member may include a disk disposal portion having a disk disposed thereon and a motor mounting part formed at the center of the disk disposal portion and bent from the disk disposal portion downwardly in an axial direction.

A connection point between the motor mounting part and the disk disposal portion on the bottom surface of the base member may have a first radius of curvature.

An outer side portion of the motor mounting part may be bent from a central portion thereof, and the bent portion may have a second radius of curvature.

The first radius of curvature may be smaller than the second radius of curvature.

The flexible printed circuit board may be disposed on a bottom surface and an outer peripheral surface of the motor mounting part and a bottom surface of the disk disposal portion.

An outer peripheral surface of the motor mounting part may be bent so as to have a predetermined radius of curvature, and a portion of the outer peripheral surface of the motor mounting part may be flat so that the flexible printed circuit board can be disposed thereon.

A portion of an inner peripheral surface of the motor mounting part corresponding to the flat portion of the outer peripheral surface thereof may be flat.

The base member may have a through-hole formed therein so that a lead wire of a coil wound around a core passes therethrough, and the flexible printed circuit board may have a guide hole formed therein so as to correspond to the through-hole.

The guide hole may have a diameter smaller than that of the through-hole.

The base assembly may further include a solder part electrically bonding the lead wire of the coil and the flexible printed circuit board to each other, wherein the solder part is formed around the guide hole.

According to another aspect of the present disclosure, a spindle motor may include: the base assembly as described above; a stator holder fixed to the base assembly; a core coupled to the stator holder and having a coil wound therearound in order to generate rotational driving force; a sleeve coupled to the base assembly and rotatably supporting a shaft; and a rotor fitted into an upper end portion of the shaft and rotating together therewith.

According to another aspect of the present disclosure, a hard disk drive may include: the spindle motor as described above rotating a disk by power applied thereto through a board; a magnetic head writing data to and reading data from the disk; and a head driving part moving the magnetic head to a predetermined position on the disk.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view of a spindle motor according to an exemplary embodiment of the present disclosure;

FIG. 2 is a half cross-sectional view of the spindle motor according to an exemplary embodiment of the present disclosure;

FIG. 3 a half cross-sectional view of the spindle motor showing a modified example of a position of a solder part electrically connecting a lead wire of a coil and a flexible printed circuit board to each other;

FIG. 4 is a rear view of a base assembly of the spindle motor according to an exemplary embodiment of the present disclosure;

FIG. 5 is a rear view showing a modified example of a through-hole and a guide hole of the base assembly;

FIG. 6 is a perspective view of a base member according to an exemplary embodiment of the present disclosure;

FIG. 7 is a rear perspective view of the base member according to an exemplary embodiment of the present disclosure;

FIG. 8 is a partially cut-away perspective view of the base member according to an exemplary embodiment of the present disclosure; and

FIG. 9 is a schematic cross-sectional view of a disk driving device using the spindle motor according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

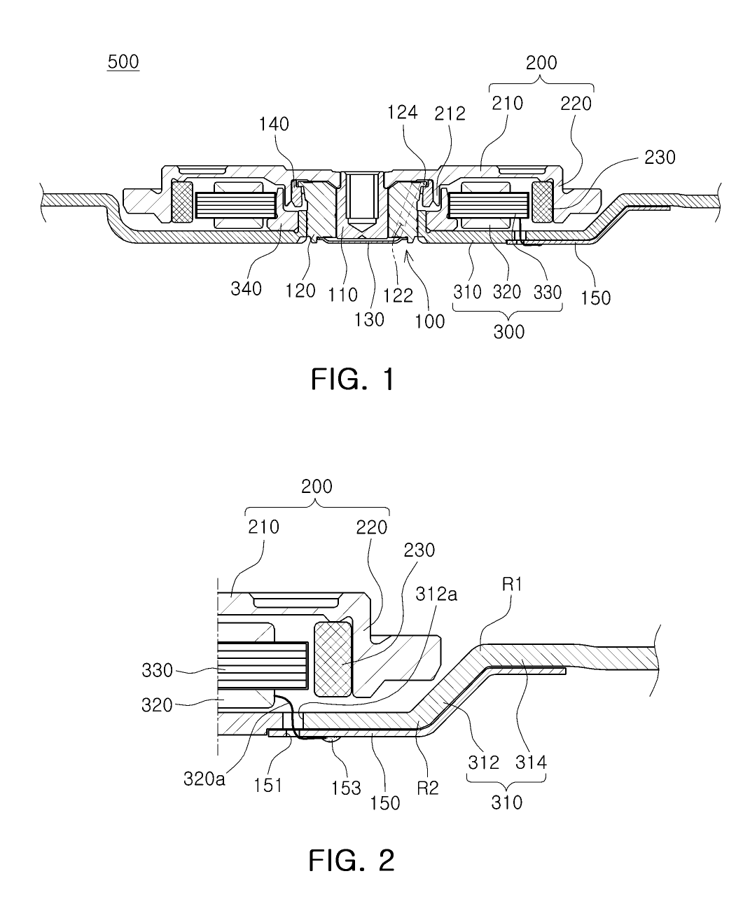

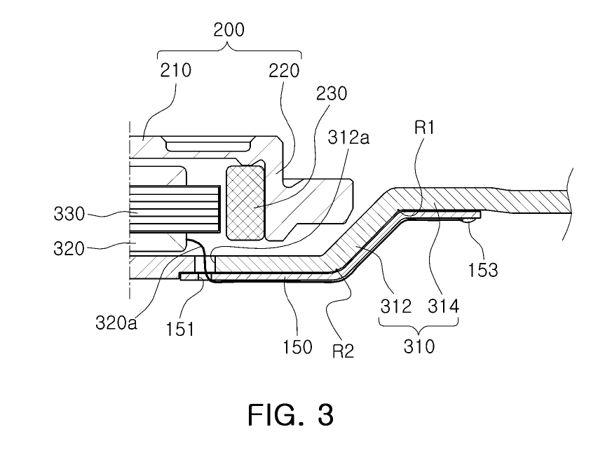

FIG. 1 is a schematic cross-sectional view of a spindle motor according to an exemplary embodiment of the present disclosure; FIG. 2 is a half cross-sectional view of the spindle motor according to an exemplary embodiment of the present disclosure; and FIG. 3 a half cross-sectional view of the spindle motor showing a modified example of a position of a solder part electrically connecting a lead wire of a coil and a flexible printed circuit board to each other.

Referring to FIGS. 1 through 3, a spindle motor 500 according to an exemplary embodiment of the present disclosure may include a hydrodynamic bearing assembly 100, a stator 300, and a rotor 200.

Terms with respect to directions will first be defined. As viewed in FIG. 1, an axial direction refers to a vertical direction based on a shaft 110, and an outer diameter or inner diameter direction refers to a direction towards an outer edge of the shaft 110 based on the shaft 110 or a direction towards the center of the shaft 110 based on the outer edge of the shaft 110.

In addition, a circumferential direction refers to a direction of rotation along an outer peripheral surface of the rotor 200 or the shaft 110.

The hydrodynamic bearing assembly 100 may include the shaft 110, a sleeve 120, and a cover plate 130.

The sleeve 120 may support the shaft 110 so that an upper end of the shaft 110 protrudes in an upward axial direction and maybe formed by forging Cu or Al or sintering Cu—Fe based alloy powders or SUS based powders.

In this configuration, the shaft 110 may be inserted into a shaft hole of the sleeve 120 so as to form a micro clearance with the shaft 110 and the shaft hole of the sleeve 120. The micro clearance may be filled with a lubricating fluid, and rotation of the shaft 110 may be more smoothly supported by radial dynamic grooves (not shown) formed in at least one of an outer diameter of the shaft 110 and an inner diameter of the sleeve 120.

The radial dynamic grooves (not shown) may be formed in an inner peripheral surface of the sleeve 120, which is an inner portion of the shaft hole of the sleeve 120, and may generate pressure so that the shaft 110 may smoothly rotate in a state in which the shaft 110 is spaced apart from the inner peripheral surface of the sleeve 120 by a predetermined interval at the time of being rotated.

However, the radial dynamic grooves (not shown) are not limited to being formed in the inner peripheral surface of the sleeve 120 as described above, but may also be formed in an outer peripheral surface of the shaft 110. In addition, the number of radial dynamic grooves is not limited.

Here, the radial dynamic groove (not shown) may have at least one of a herringbone pattern, a spiral pattern, and a helical pattern. However, the radial dynamic groove may have any pattern as long as radial dynamic pressure may be generated thereby.

In addition, thrust dynamic grooves (not shown) may be formed in at least one of an upper surface of the sleeve 120 and one surface of the rotor 200 facing the upper surface of the sleeve 120, and the rotor 200 may rotate together with the shaft 110 in a state in which it secures predetermined floating force by the thrust dynamic grooves (not shown).

Here, the thrust dynamic grooves (not shown) may have a herringbone pattern, a spiral pattern, or a helical pattern, similar to the radial dynamic grooves (not shown). However, the thrust dynamic grooves (not shown) are not necessarily limited to having the above-mentioned patterns, but may have any pattern as long as thrust dynamic pressure may be generated thereby.

In addition, the sleeve 120 may have at least one bypass channel 122 formed therein so as to allow upper and lower portions thereof to be in communication with each other.

The bypass channel 122 may disperse pressure in the lubricating fluid to maintain balance in the pressure and may move air bubbles, or the like, present in the lubricating fluid, to be discharged by circulation.

The cover plate 130 may be coupled to the sleeve 120 in a state in which it maintains a clearance between the cover plate 130 and a lower portion of the sleeve 120.

The cover plate 130 may accommodate the lubricating fluid in the clearance formed between the cover plate 130 and the sleeve 120 to serve as a bearing supporting a lower surface of the shaft 110.

Here, in terms of a method of fixing the cover plate 130, several methods such as a welding method, a caulking method, a bonding method, or the like, may be provided, which may be selectively applied depending on a structure and a process of manufacturing a product.

The rotor 200 may be a rotating structure provided so as to be rotatable with respect to the stator 300 and may include an annular ring-shaped magnet 230 disposed on an inner peripheral surface thereof, wherein the annular ring-shaped magnet 230 corresponds to a core 330, having a predetermined interval therebetween, and the core 330 has a coil 320 wound therearound.

Here, the rotor 200 may include a hub base 210 press-fitted into and fixed to an upper end of the shaft 110 and a magnet supporting part 220 bent from the hub base 210 downwardly in an axial direction and supporting the magnet 230.

In addition, the magnet 230 may be a permanent magnet generating magnetic force having a predetermined strength by alternately magnetizing an N pole and an S pole thereof in the circumferential direction.

Rotational driving of the rotor 200 will be schematically described hereinafter. When power is supplied to the coil 320 wound around the core 330, driving force capable of rotating the rotor 200 may be generated by electromagnetic interaction between the magnet 220 and the core 330 having the coil 320 wound therearound.

Therefore, the rotor 200 may rotate. As a result, the shaft 110 to which the rotor 200 is fixed may rotate together with the rotor 200.

The rotor 200 may be provided with a main wall part 212 protruding from one surface thereof in the downward axial direction.

The main wall part 212 may have a stopper 140 coupled to an inner peripheral surface thereof, and an inner peripheral surface of the stopper 140 and an outer peripheral surface of the sleeve 120 may have a sealing part formed therebetween in order to seal the lubricating fluid.

That is, the main wall part 212 may protrude from one surface of the rotor 200, which is a rotating member, to fix the stopper 140 to the inner peripheral surface thereof, and the lubricating fluid may be sealed between the stopper 140 and the sleeve 120, a fixed member.

The outer peripheral surface of the sleeve 120 corresponding to the inner peripheral surface of the stopper 140 may be tapered so that the lubricating fluid is sealed.

Here, an upper portion of the sleeve 120 maybe provided with a flange part 124 protruding in the outer diameter direction, and a lower surface of the flange part 124 may face a portion of an upper surface of the stopper 140.

Therefore, in the case in which the shaft 110 and the rotor 200, rotating members, are excessively floated, a portion of the upper surface of the stopper 140 may be caught by the lower surface of the flange part 124, whereby excessive floating of the rotating members may be prevented.

The stator 300 may include the coil 320, the core 330, a stator holder 340, and a base member 310.

The stator 300 may be a fixed structure including the core 330 having the coil 320 wound therearound, wherein the coil 320 generates electromagnetic force having a predetermined magnitude when power is applied thereto.

The core 330 maybe fixedly disposed over the base member 310 provided with a flexible printed circuit board 150 having pattern circuits printed thereon, the base member 310 corresponding to the core 330 having the coil 320 wound therearound may have a through-hole 312a formed therein so that a lead wire of the coil 320 passes therethrough, the through-hole 312a having a predetermined size, and the coil 320 may be electrically connected to the flexible printed circuit board 150 so that external power is supplied.

The base member 310 may have the stator holder 340 coupled thereto, and the stator holder 340 may have the core 330 fixed thereto.

An outer peripheral surface of the stator holder 340 may be stepped so that the core 330 is stably fixed thereto.

The base member 310 may be manufactured by performing plastic deformation (for example, press working) on a steel sheet.

In detail, the base member 310 may be manufactured by performing plastic working on a sheet, that is, a cold rolled steel sheet (SPCC, SPCE, or the like), a hot rolled steel sheet, stainless steel, or a lightweight alloy steel sheet formed of a material such as a boron alloy, a magnesium alloy, or the like.

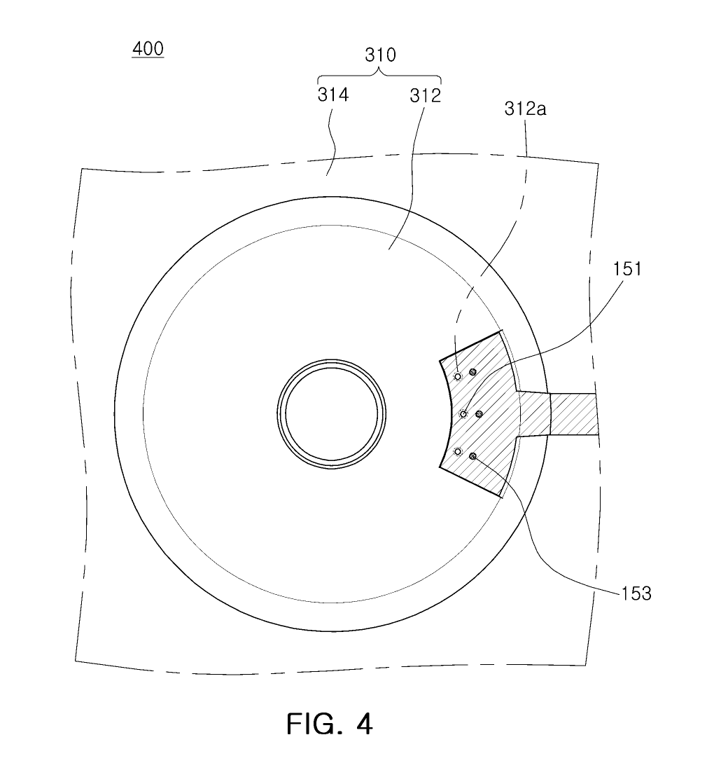

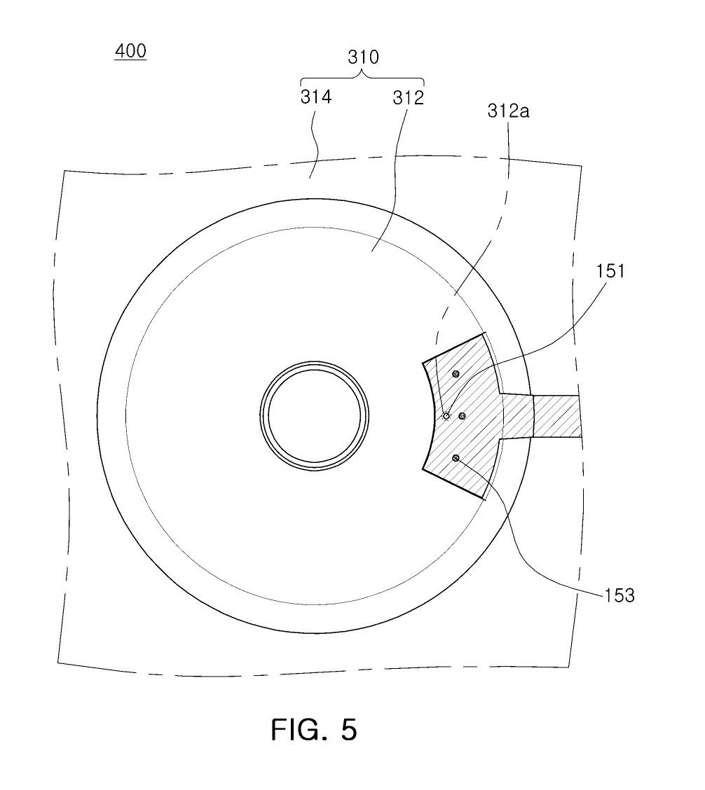

FIG. 4 is a rear view of a base assembly of the spindle motor according to an exemplary embodiment of the present disclosure; and FIG. 5 is a rear view showing a modified example of a through-hole and a guide hole of the base assembly.

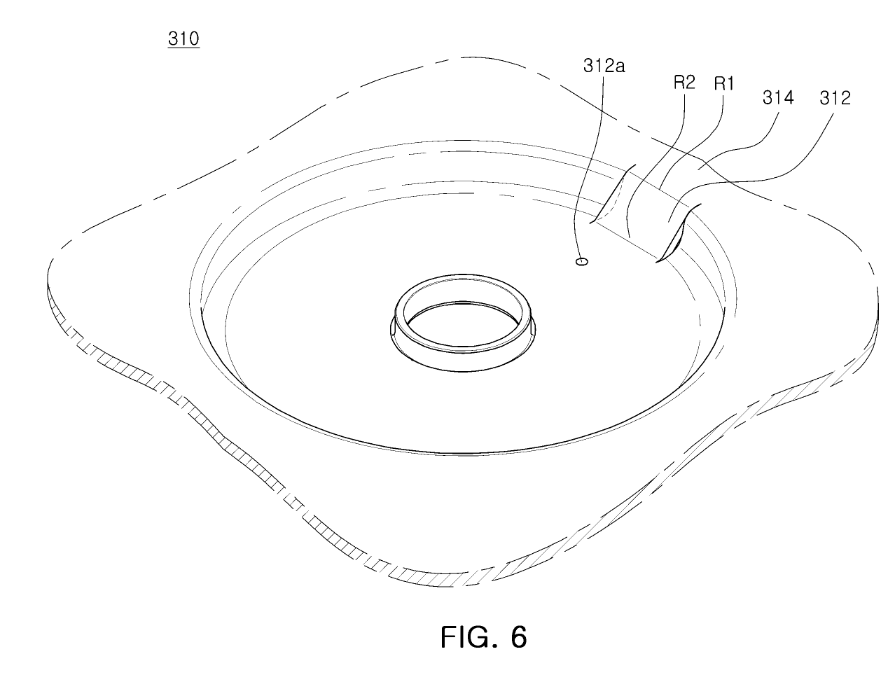

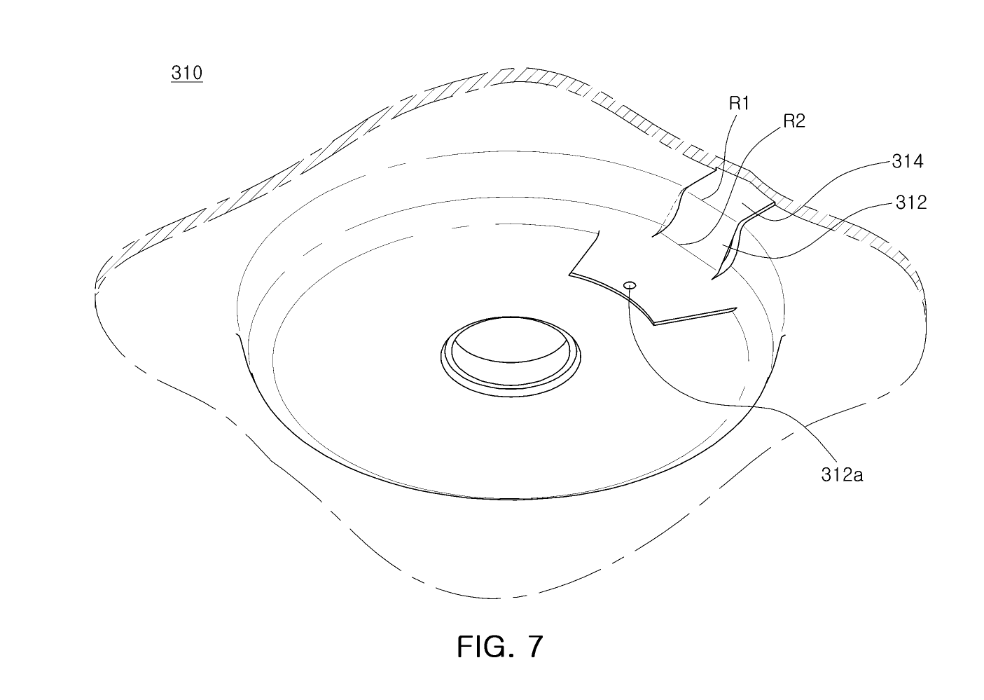

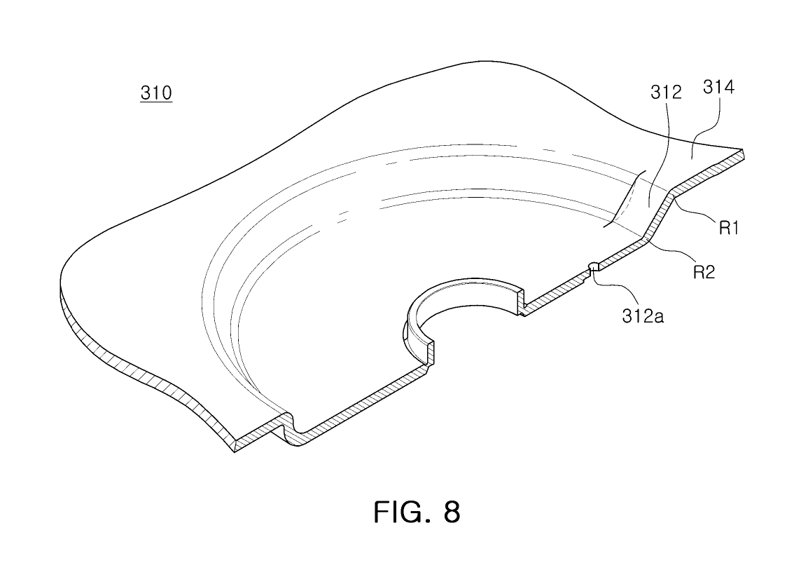

In addition, FIG. 6 is a perspective view of a base member according to an exemplary embodiment of the present disclosure; FIG. 7 is a rear perspective view of the base member according to an exemplary embodiment of the present disclosure; and FIG. 8 is a partially cut-away perspective view of the base member according to an exemplary embodiment of the present disclosure.

Referring to FIGS. 4 through 8, a base assembly 400 of the spindle motor 500 according to an exemplary embodiment of the present disclosure may include a base member 310 and a flexible printed circuit board 150.

Since the base member 310 is formed by performing plastic deformation on a steel sheet, at least a portion thereof may be bent.

That is, the base member 310 may include a disk disposal portion 314 having a disk disposed thereon and a motor mounting part 312 formed at the center of the disk disposal portion 314 and bent from the disk disposal portion 314 downwardly in an axial direction.

Since the motor mounting part 312 is bent at the center of the disk disposal portion 314, a connection point between the motor mounting part 312 and the disk disposal portion 314 may have a first radius R1 of curvature.

In detail, the first radius R1 of curvature may refer to the connection point between the motor mounting part 312 and the disk disposal portion 314 in a bottom surface of the base member 310.

A central portion of the motor mounting part 312 may be flat, and an outer side portion thereof may be bent from the central portion thereof in an upward axial direction to form an outer peripheral surface thereof and may be bent again to form the disk disposal portion 314.

In addition, the motor mounting part 312 may have a fixing hole formed in the center thereof so that the sleeve 120 can be inserted thereinto and fixed thereto.

That is, the motor mounting part 312 may generally have a cup shape and may have a bottom surface positioned in a position lower than that of a bottom surface of the disk disposal portion 314.

Since the outer side portion of the motor mounting part 312 is bent from the central portion thereof in the upward axial direction, the bent portion may have a second radius R2 of curvature.

In detail, the second radius R2 of curvature may refer to a bent portion in the bottom surface of the motor mounting part 312.

Here, the first radius R1 of curvature may be smaller than the second radius R2 of curvature.

The flexible printed circuit board 150 may be disposed on the bottom surface of the base member 310. In detail, the flexible printed circuit board 150 may be disposed on the bottom surface of the motor mounting part 312, the outer peripheral surface of the motor mounting part 312, and the bottom surface of the disk disposal portion 314.

Since the base member 310 is formed by performing the plastic deformation on the steel sheet, at least a portion thereof may be bent. When a portion of the base member 310 to which the flexible printed circuit board 150 is adhered has a curved shape, adhesion between the flexible printed circuit board 150 and the base member 310 may be decreased. As a result, there may be a risk that the flexible printed circuit board 150 may be separated from the base member 310.

However, a surface having the flexible printed circuit board 150 disposed thereon on the bottom surface of the base member 310 provided in the spindle motor 500 according to an exemplary embodiment of the present disclosure may be flat.

Here, the outer peripheral surface of the motor mounting part 312 may be formed in a curved shape so as to have a predetermined radius of curvature in the circumferential direction. However, a portion of the outer peripheral surface of the motor mounting part 312 may be flat so that the flexible printed circuit board 150 is disposed thereon.

The flat surface may be formed by pressing inner and outer peripheral surfaces of the motor mounting part 312 having the curved shape.

Therefore, a portion of the inner peripheral surface of the motor mounting part 312 as well as the outer peripheral surface thereof may be flat.

That is, a portion of the inner peripheral surface of the motor mounting part 312 corresponding to the flat portion of the outer peripheral surface thereof may be flat.

In addition, since the flat surface may be formed by pressing the inner and outer peripheral surfaces of the motor mounting part 312, density of the base member 310 at a portion at which the flat surface is formed may be high. Therefore, rigidity of the base member 310 may be improved.

The base member 310 may have at least one through-hole 312a formed therein so that a lead wire 320a of the coil 320 passes therethrough, wherein the lead wire 320a of the coil 320 may be electrically connected to the flexible printed circuit board 150 so that external power is supplied.

The flexible printed circuit board 150 may have a guide hole 151 formed therein so as to correspond to the through-hole 312a, and the lead wire 320a of the coil 320 may pass through the through-hole 312a and the guide hole 151 and then be electrically connected to the flexible printed circuit board 150.

Here, the guide hole 151 may have a diameter smaller than that of the through-hole 312a.

The lead wire 320a may be fixed to the flexible printed circuit board 150 by a solder part 153 in order to be electrically connected to the flexible printed circuit board 150, and the solder part 153 may be formed around the guide hole 151, as shown in FIG. 2.

However, the solder 153 is not limited to being formed around the guide hole 151, but may also be formed in a position corresponding to the bottom surface of the disk disposal portion 314, as shown in FIG. 3.

In addition, although not shown, an insulating member (not shown) formed of an insulating material including a resin material such as epoxy, or the like, may be inserted into and fixed to the through-hole 312a in order to insulate the lead wire 320a of the coil 320 from the base member 310.

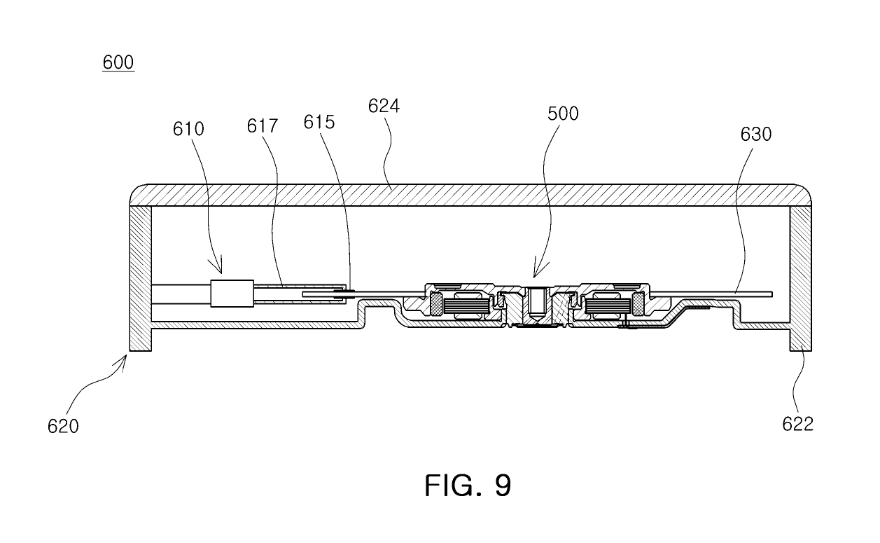

FIG. 9 is a schematic cross-sectional view of a disk driving device using the spindle motor according to an exemplary embodiment of the present disclosure.

Referring to FIG. 9, a recording disk driving device 600 having the spindle motor according to an exemplary embodiment of the present disclosure mounted therein may be a hard disk drive and may include the spindle motor 500, a head driving part 610, and a housing 620.

The spindle motor 500 may have all the characteristics of the spindle motor 500 according to an exemplary embodiment of the present disclosure described above and may have a recording disk 630 mounted thereon.

The head driving part 610 may transfer a magnetic head 615 reading information from the recording disk 630 mounted on the spindle motor 500 to a position above a surface of the recording disk 630 from which information is to be read.

Here, the magnetic head 615 maybe disposed on a support part 617 of the head driving part 610.

The housing 620 may include a motor mounting plate 622 and a top cover 624 shielding an upper portion of the motor mounting plate 622 in order to form an internal space accommodating the spindle motor 500 and the head driving part 610 therein.

As set forth above, with the base assembly, the spindle motor and the hard disk drive including the same according to an exemplary embodiment of the present disclosure, the flexible printed circuit board may be stably fixed to the base member. Therefore, separation of the flexible printed circuit board from the base member may be prevented.

While exemplary embodiments have been shown and described above, it will be apparent to those skilled in the art that modifications and variations could be made without departing from the spirit and scope of the present disclosure as defined by the appended claims.

What is claimed is:

1. A base assembly comprising:
a base member formed by performing plastic deformation on a steel sheet to be at least partially bent; and
a flexible printed circuit board disposed on a bottom surface of the base member,
wherein a surface having the flexible printed circuit board disposed thereon on the bottom surface of the base member is flat.

2. The base assembly of claim 1, wherein the base member includes a disk disposal portion having a disk disposed thereon and a motor mounting part formed at the center of the disk disposal portion and bent from the disk disposal portion downwardly in an axial direction.

3. The base assembly of claim 2, wherein a connection point between the motor mounting part and the disk disposal portion on the bottom surface of the base member has a first radius of curvature.

4. The base assembly of claim 3, wherein an outer side portion of the motor mounting part is bent from a central portion thereof, and the bent portion has a second radius of curvature.

5. The base assembly of claim 4, wherein the first radius of curvature is smaller than the second radius of curvature.

6. The base assembly of claim 2, wherein the flexible printed circuit board is disposed on a bottom surface and an outer peripheral surface of the motor mounting part and a bottom surface of the disk disposal portion.

7. The base assembly of claim 2, wherein an outer peripheral surface of the motor mounting part is bent so as to have a predetermined radius of curvature, and a portion of the outer peripheral surface of the motor mounting part is flat so that the flexible printed circuit board is disposed thereon.

8. The base assembly of claim 7, wherein a portion of an inner peripheral surface of the motor mounting part corresponding to the flat portion of the outer peripheral surface thereof is flat.

9. The base assembly of claim 1, wherein the base member has a through-hole formed therein so that a lead wire of a coil wound around a core passes therethrough, and the flexible printed circuit board has a guide hole formed therein so as to correspond to the through-hole.

10. The base assembly of claim 9, wherein the guide hole has a diameter smaller than that of the through-hole.

11. The base assembly of claim 9, further comprising a solder part electrically bonding the lead wire of the coil and the flexible printed circuit board to each other,
wherein the solder part is formed around the guide hole.

12. A spindle motor comprising:
the base assembly of claim 1;
a stator holder fixed to the base assembly;
a core coupled to the stator holder and having a coil wound therearound in order to generate rotational driving force;
a sleeve coupled to the base assembly and rotatably supporting a shaft; and
a rotor fitted into an upper end portion of the shaft and rotating together therewith.

13. A hard disk drive comprising:
the spindle motor of claim 12 rotating a disk by power applied thereto through a board;
a magnetic head writing data to and reading data from the disk; and
a head driving part moving the magnetic head to a predetermined position on the disk.
